(19) United States
(12) Patent Application Publication
(10) Pub. No.: US 2017/0151677 A1
(43) Pub. Date: Jun. 1, 2017

(54) Plug-Setting Device

(71) Applicant: KUKA Systems GmbH, Augsburg (DE)

(72) Inventors: Stefan Mayr, Friedberg (DE); Yuecel Kara, Augsburg (DE); Julian Stockschlaeder, Augsburg (DE); Richard Zunke, Augsburg (DE)

(73) Assignee: KUKA Systems GmbH, Augsburg (DE)

(21) Appl. No.: 15/315,195

(22) PCT Filed: Jun. 1, 2015
(86) PCT No.: PCT/EP2015/062136

§ 371 Date: Nov. 30, 2016

(30) Foreign Application Priority Data
Jun. 2, 2014 (DE) 20 2014 102 559.6

(51) Int. Cl. B25J 15/00; B23P 19/04; G05B 19/418; B25J 19/06

(52) U.S. Cl. CPC B25J 15/0019; B25J 19/06; B23P 19/04; G05B 19/41805; G05B 2219/40202; G05B 2219/43057; B23P 2700/50; Y10S 901/41

(57) ABSTRACT

A device for automatically setting plugs on motor-vehicle body parts includes an industrial robot which has a plug-setting tool and a plug magazine, wherein the plug-setting device is designed to be suitable for human-robot collaboration (HRC). The plug-setting tool has one or more HRC-suitable electric drives, the speed and force or torque of which are limited to HRC-permissible values. A method for automatic setting of plugs with a plug-setting device that includes an industrial robot and a plug-setting tool includes carrying the plug-setting tool with the industrial robot, wherein the plug-setting tool has a plug magazine and the plug-setting device is designed for human-robot collaboration.

### CROSS-REFERENCE

This application is a national phase application under 35 U.S.C. §371 of International Patent Application No. PCT/EP2015/062136, filed Jun. 1, 2016 (pending), which claims the benefit of German Patent Application No. DE 10 2014 102 559.6 filed Jun. 2, 2014, the disclosures of which are incorporated by reference herein in their entirety.

### TECHNICAL FIELD

The invention concerns a plug-setting device with the features in the preamble of the main claim.

### BACKGROUND

One such type of device for the automatic setting of plugs to automotive body parts is known from DE 10 2010 005 798 A1. The plug-setting device comprises a multiaxial industrial robot with a plug-setting tool that is equipped with a plug magazine.

It is the objective of the present invention to demonstrate an improved technique for plug-setting.

### SUMMARY

The invention solves this objective with the inventive plug-setting device and method disclosed herein.

The inventive plugging technique, i.e. the plug-setting device and the plug-setting method, has functional and safety-related advantages.

In the modern automated work and manufacturing world, it is advantageous when humans can cooperate or collaborate with industrial robots, in particular tactile robots. This is referred to as human-robot cooperation or collaboration (abbreviated HRC). Using contact-sensitive protective measures, physical contact between the human body and the industrial robot or its process tools is permitted within limits. For an HRC, and when using contact-sensitive protective measures, specific limits have to be observed, which differ with respect to the type of stress and area of contact with the human body, in particular a worker's body. Physical contact with the human body can be differentiated according to the occurring impact force and the occurring clamping and squeezing force. The impact force is a dynamic force that is transmitted in the first force impulse upon contact with the human body (Peak). The clamping and squeezing force is the static force that is preserved after a first force impulse. The force limits for the respective types of stress for individual regions of the body are specified in a body model.

The standardization, in particular ISO/TS 15066 and EN ISO 10218-1, 2, includes specifications for HRC with respect to protective measures, sensory reliability and the like. In HRC, a collision that has occurred between the robot or its tool and an obstacle, in particular a worker, is detected with a recording device and for safety reasons a protective measure, in particular a halt or reverse movement of the robot, is initiated. The detection of the collision can take place by physical contact and, if need be, with a measurement of the occurring collision forces.

The inventive plug-setting technique is designed to be HRC-capable and, unlike DE 10 2010 005 798 A1, is also suitable for use in a working environment to which people have access as well. This has advantages for the consolidation of work content and the thereby achievable increase in efficiency. The plugs can be set automatically, while a worker in immediate proximity can perform other tasks on the same workpiece. This includes the worker checking the set plugs.

On the other hand, due to the HRC-capability, the worker is protected against accidents, and in particular their negative consequences. The HRC-capability of the plug-setting device can be achieved and optimized using a variety of measures. These measures can be effective individually and in combination with one another.

In the event of a collision with the worker, through the HRC-capable electric drive technology, injuries are prevented by limiting the speed and the force or the torque. This can, in particular, concern the risk of crushing through movements of tool parts, in particular the setting unit and its plug receptacle. DE 10 2005 005 798 A1 poses particular risks in this respect and is unsuitable for HRC use.

The plug-setting tool can further be shielded with an HRC-capable protective cover to minimize the risk of injury. A soft and flexible, as well as a rounded design is advantageous here. In the inventive plug-setting device it is possible, despite this shielding of the plug tool, to change or reload a plug magazine automatically, so that long-term use is possible in spite of the HRC-protection. It is in particular not necessary to remove the HRC protective cover to replenish the supply of plugs and to interrupt the plug-setting process to do so. With the inventive modular design of the plug-setting tool, it is also possible to work efficiently with a wide variety of plugs in terms of their shape and size. Changing the magazine can be performed automatically. On the other hand, it is also possible to accommodate multiple magazines with the same or different plug formats on the plug-setting tool. Due to the standard magazine receiver and the standard mounting adapter on the otherwise different magazines, the range of variety can be expanded at will. When changing the plug format, work can continue with the same plug-setting tool. A tool change is not needed. The inventive plug-setting technique provides functional and structural improvements as well. With the rotating device, the plug receptacle can execute different and less sweeping rotational movements than the one in DE 10 2010 005 798 A1. This improves the tool function and the speed. The occurrence of large gaps or displacements and the associated crushing hazard can be avoided as well. In particular, an HRC-safe closed contour and a tight fit of the plug magazine and the plug receptacle during the setting operation can be achieved. The protective cover in this tool area can be recessed, whereby the crushing hazard is avoided by the stated measures.

It is also possible to achieve a swivel lock for the plug receptacle, thereby assuring its position during the setting operation, i.e. during the insertion and setting of a plug in an opening on the workpiece. This has functional and safety-related advantages, in particular the formation of the aforementioned HRC-safe, closed contour and the tight fit of the plug magazine and the plug receptacle. A separate actuator for the swivel lock is not required.

There are also advantages with respect to function and kinematics when setting the plugs. As in DE 10 2010 005 798 A1, the required contact pressure and advance motion to insert and set a plug can be provided by an own drive that is integrated in the plug receptacle. The inventive plug-setting technique provides many other options. Advance and force, in particular, can be provided by the industrial robot. The design and construction costs and the space requirement of the plug-setting tool can thus be reduced. The separate drive in the plug receptacle is no longer needed. On the other hand, the plug-setting process can be accelerated. The setting of a plug and the reloading of another plug at the plug receptacle can overlap.

This type of design of the plug-setting tool suggests the use of a tactile industrial robot, which can realize the plug-setting process quickly and safely with an attached, or possibly even integrated, sensor system. With the aid of the sensor system the workpiece opening can be located and the plug can be properly aligned. Then again, the automatic setting process can be controlled and monitored via the detection of the occurring mechanical loads or forces/torques. This includes the possibility of inferring the correct plug position on the workpiece from the load profile, and the opportunity for quality monitoring.

The tactile capabilities of the industrial robot have advantages with respect to the HRC-capability as well. Any resistance, in particular a collision with an obstacle, in particular also with a worker, that occurs unexpectedly, can be detected by the sensor system and evaluated. With the appropriate software, the industrial robot can then initiate appropriate HRC measures, e.g. halting the motion, reverse operation and possibly also circumventing the obstacle.

A tactile industrial robot can be configured in a variety of ways. Tactile articulated arm industrial robots that are suitable for plug-setting operation are known, for example, from DE 10 2007 063 009 Al, DE 10 2007 014 023 A1 and DE 10 2007 028 758 B4.

Other advantageous embodiments of the invention are described in the dependent claims.

### BRIEF DESCRIPTION OF THE DRAWINGS

The invention is shown schematically as an example in the drawings. The drawings show:

FIG. 1 is a plug-setting device with an industrial robot and a plug-setting tool on a workpiece,

FIG. 2 is an enlarged perspective view of the plug-setting tool of FIG. 1, and

FIG. 3 is a perspective plan view onto the plug-setting tool of FIGS. 1 and 2.

### DETAILED DESCRIPTION

The invention concerns a plug-setting device (1) and a plug-setting process. It further concerns a plug-setting tool (3).

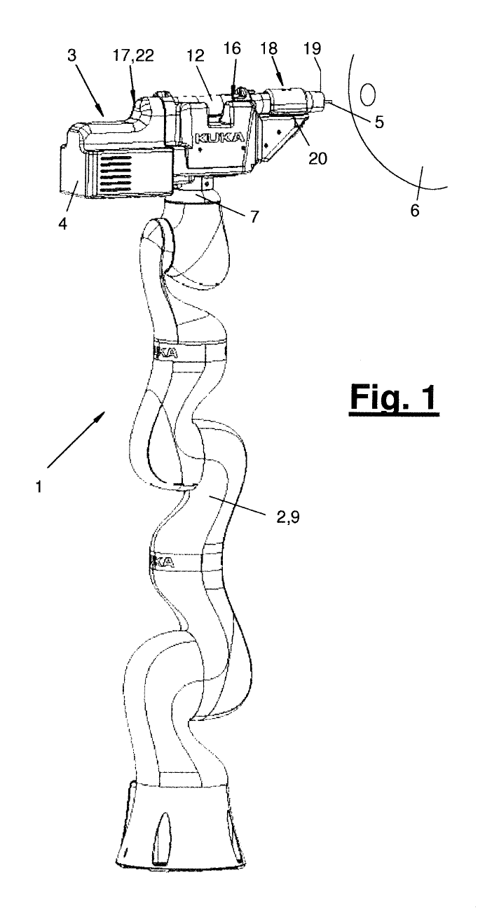

The claimed device (1) serves the automatic setting of plugs (5) on workpieces (6), in particular automotive body parts, as shown in FIG. 1. The schematically suggested plug (5) is set into an opening on the workpiece (6) and is pressed in, forming a clamped or catch connection. The spatial position of the opening is known and can be approached directly. On the other hand, it is also possible to locate the workpiece opening with the plug-setting device (1). This reduces the programming effort and increases the flexibility.

The plug-setting device (1) includes a multiaxial handling device (2), in particular an industrial robot, and a plug-setting tool (3) guided by the robot. FIG. 1 shows an example of such a design. The industrial robot (2) is designed to be multi-armed and possesses multiple controllable and adjustable robot axes. It can have any number and combination of rotational and/or translational robot axes. The industrial robot (1) shown in FIG. 1 has seven robot axes and four robot arms, including a base, two intermediate links and an end link or output link (7), which is a movable, in particular rotating, output element (8) in the form of a flange or the like. The intermediate links of the industrial robot (1) can have an angled shape and, by means of an integrated robot axis, can be rotatable about their longitudinal extension. Any number of other robot configurations is possible in place of the depicted arrangement. The industrial robot (2) can be arranged in a stationary or non-stationary manner. In a non-stationary arrangement, the industrial robot (2) can have a travel axis or be arranged on a possibly multiaxial vehicle that is movable within the space.

The industrial robot (2) has tactile properties and includes an appropriate sensor system (9), which detects and evaluates loads acting from the outside or external loads, in particular forces and/or torques. In the depicted robot arrangement, the sensor system (9) can be integrated in the industrial robot (2), whereby torque sensors, for example, are located on the rotational robot axes and their mounts. Position encoders, particularly rotation encoders are disposed here as well. Alternatively or additionally, a sensor system that records loads can be disposed in the output area of the industrial robot (2), e.g. between the output element (8) and the plug-setting tool (3).

The multiaxial industrial robot (1) is preferably designed as an articulated arm robot. It is programmable and includes a robot control system (not shown), to which the plug-setting tool (3) can also be connected.

An operating material supply for the required operating materials, e.g. electrical signal and/or power currents, fluids, in particular compressed air, coolants or the like, for the plug-setting tool (3) may be in place as well. The operating material can be supplied from the outside or internally through the robot links. A suitable coupling, that is for example configured as a media coupling and that can potentially also facilitate an automatic tool change, can be attached to the output element (8) for this purpose.

The plug-setting device (1) is designed to be compatible with a human-robot collaboration (HRC). The tactile industrial robot (1) with the sensor system (9) can in and of itself be designed to be HRC-capable. For this purpose, appropriate software can be stored and implemented in the robot control system. The plug-setting tool (3) is likewise designed to be HRC-capable.

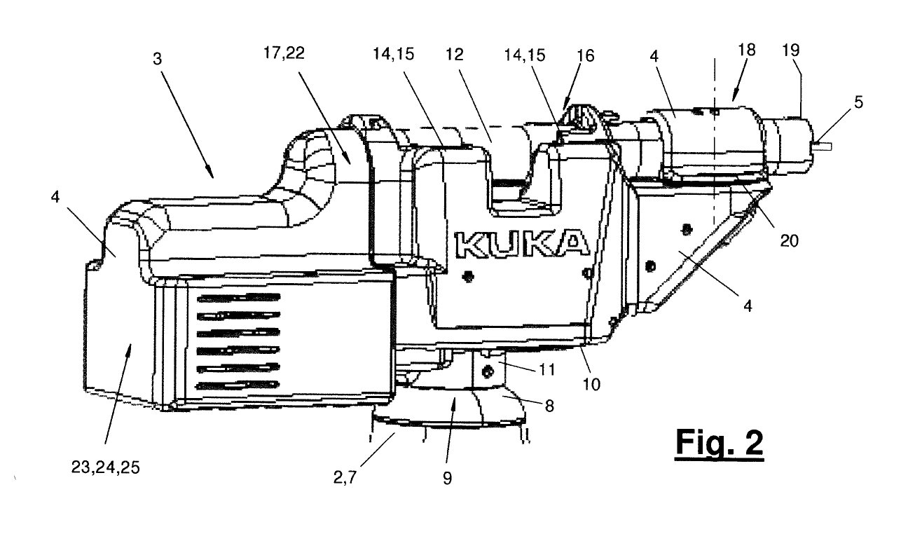

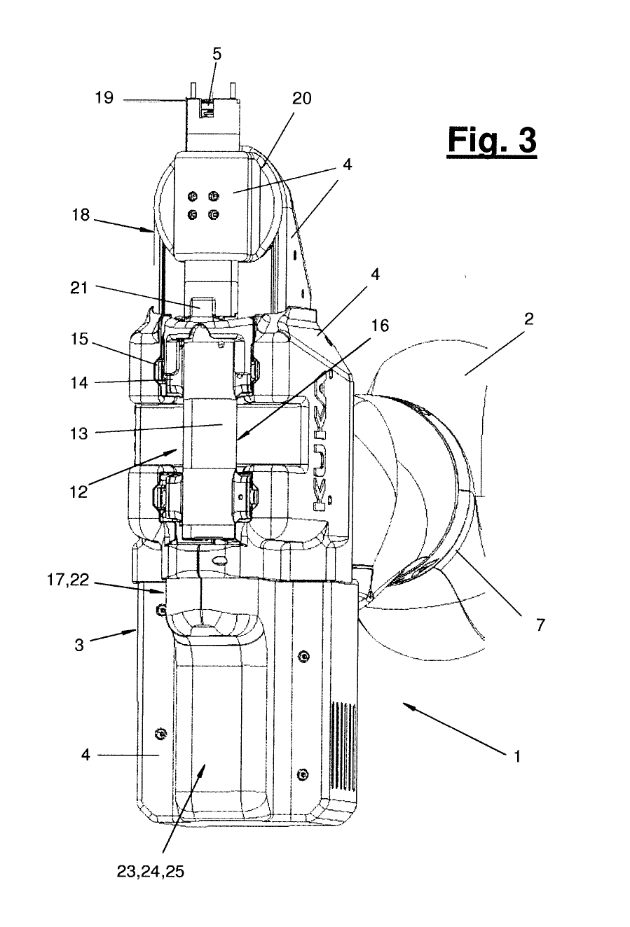

As illustrated in FIGS. 2 and 3 in an enlarged view, the plug-setting tool (3) includes a frame (10) with a connector (11) for use with the robot and its output element (8). The plug-setting tool (3) further comprises a plug magazine (12) and a setting unit (18). The plug magazine and the setting unit can be present one at a time or in multiples, as needed. The setting unit (18) comprises a plug receptacle (19) and a rotating device (20) to create a controlled rotating motion of the plug receptacle (19) about a rotational axis, which is shown in FIG. 2. The rotational axis is oriented to be transverse to the longitudinal axis of the preferably rod-shaped or cylindrical plug magazine (12). The axes can intersect.

The plug-setting tool (3) and its components are surrounded by an HRC-capable protective cover (4). The protective cover (4) may be formed from of a soft, and in the event of a collision flexible, material, such as rubber or a foamed plastic, and has rounded contours. The protective cover (4) surrounds and encloses the frame (10), the rotating device (20), an advancement mechanism (17), a loading device (22) and the one or more drives (23, 24, 25), described below, for the components of the plug-setting tool (3). The protective cover (4) can be one-piece or multi-piece. A cap-like cover part can also cover the plug receptacle (19), at least in areas.

In the functional area of the plug magazine (12), the protective cover (4) includes an opening (16), which provides access to the plug magazine (12) and allows an automatic exchange or reloading of the plug magazine (12). The plug magazine (12) likewise has rounded contours and is adapted to the opening (16), thus preventing hazardous crushing gaps or the like. In the area of the setting unit (18), the protective cover (4) can also be recessed, thereby allowing functional movements of the setting device (18) and also largely preventing crushing gaps and the like that are likely to cause injuries. The setting unit (18) also has an HRC-favorable rounded shape. Below the setting unit (18), the frame (10) is clad with the protective cover (4).

For the aforementioned automatic magazine change, the plug-setting device (1) can include a corresponding stationary provision for one or more plug magazines (12), as well as the corresponding ancillary equipment for the magazine change. For the sake of clarity, these are not shown. The industrial robot (2) moves the plug-setting tool (3) to this provision along a programmed path, and positions it with the opening (16) across from said ancillary equipment.

The plug-setting tool (3) is preferably designed in a modular fashion and can accommodate a variety of plug magazines (12) for different plug formats. The plug (5) shown as an example in the drawings can be configured in a variety of ways. It includes a plate or cap-like head part for at least sectional coverage of the workpiece opening and a foot part suitable for a plug catch, with one or more transversely protruding feet and a contour suitable for a catch or snap connection. The plug (5) has a shape that is appropriately adapted to the opening in the workpiece. In plan view it can, for example, be configured to be rotationally symmetric, in particular circular, or oval or prismatic. The head part of the plug (5) can have a closed wall or a through hole.

The plugs (5) are accommodated in a container (13) of the plug magazine (12) in a row, one behind the other. The plug container (13) is preferably rod or tube-shaped, and can in particular be cylindrical. It is oriented in setting direction and transverse to the output shaft of the output element (8). The plug magazine (12) can further include a loading device (22), which is only suggested in the drawings by arrows and is preferably disposed hidden within the protective cover (4). With the loading device (22), the plugs (5) in the plug container (13) are pushed forward after the preferred individual removal of the respective front plug (5). The loading device (22) can alternatively also be used to insert and reload a series of plugs in the plug magazine (12).

The plug-setting tool (3) comprises a standard magazine holder (15) for a variety of plug magazines (12), which can also be changed automatically as needed. Here all the different plug magazines (12) include a plug container (13) that is matched to the respective plug format. The plug container has a standard mounting adapter (14) that is adapted to the magazine receiver (15). For the various plug magazines (12), the standard mounting adapter (14) always has the same and preferred outer accommodation contour that is adapted to the standard magazine receiver (15). The container formats that vary with the plug geometry are equalized via the mounting adapter (14).

The magazine receiver (15) and the mounting adapter (14) are detachably coupled to one another. This is preferably carried out via a positive-locking connection, in particular a flexible snap connection or clip connection. This is also advantageous for the aforementioned automatic magazine change. This snap connection also automatically positions the rod magazine (12) in the magazine mounting (15).

The plug-setting tool (3) can include an advancement mechanism (17) for an axial relative movement between the plug magazine (12) and the plug receptacle (19). The advancement mechanism (17) can, for example, effect an axial advance and return stroke of the rod magazine (12). Via this, the plug magazine (12) can be moved toward the plug receptacle (19), and possibly also brought into engagement with it in a positive-locking manner. Alternatively, the advancement mechanism (17) can move a part of the plug receptacle (19). The advancement mechanism (17) can likewise be disposed hidden in the protective cover (4). Through this axial relative movement, the HRC-safe, closed outer contour, shown in FIGS. 2 and 3, can be formed, whereby the front end of the plug magazine (12) and the rear end of the plug receptacle (19) lie close to one another. They can engage into one another in a positive-locking manner by means of projections and recesses. In this way a swivel lock (21), which preferably acts with a mechanical form fit, can be formed as well.

The plug receptacle (19) is rotated with the rotating device (20), whereby, at the rear end, it is loaded at the plug magazine (12) with a new plug (5) and, with the front end, it can insert the plug (5) that it has accepted here into the workpiece opening. The rotary device (20) can likewise be disposed hidden in the protective cover (4).

This advance and setting motion can be effected by a setting drive with an extendable tappet that is integrated in the plug receptacle (19) as in DE 10 2010 005 798 A1. Alternatively, it is possible to execute the advance and setting motion with the industrial robot (2).

By means of said sensor system (9), which can alternatively also be disposed on the setting unit (18), the distribution of forces when setting a plug (5) can be tracked. The plug (5) is initially positioned at the workpiece opening, which can be performed by means of an appropriately precise position specification or by means of a search function of the industrial robot (2). Subsequently, the plug (5) is advanced, whereby it plunges into the workpiece opening with its foot region. In doing so, the foot region is preferably deformed to create a mechanical catch or snap connection, which manifests itself in a corresponding increase in force. When it has snapped into place, the force acting in advance direction again drops rapidly, which can be detected and evaluated as a signal of success and completion of the setting process. After the plug has snapped into place the force increases again.

The described setting unit (18) can also have a different structural design and function, whereby the advance motion and the delivery force is supplied by the industrial robot (2) and the plug (5) is expelled from the plug receptacle (19) in a suitable manner. This can be performed with another relative movement between the plug and a tappet, for example, as in DE 10 2010 005 798 A1.

In the depicted embodiment, the plug receptacle (19) has two receiving locations for a plug (5), so that a plug (5) can be set in the front and, at the same time, a new plug (5) can be reloaded in the rear. Alternatively, the number of receiving locations on the plug receptacle (19) can be smaller or larger. It can, for example, be one, three, four or five or more.

In the depicted and preferred embodiment, the plug receptacle (19) is aligned with the plug magazine (12) during the setting operation. Alternatively it is also possible to realize a different angular position, in particular when the plug receptacle (19) has multiple receiving locations and/or multiple plug magazines (12) are disposed on the plug-setting tool (3).

The rotating device (20), the loading device (22) and the advancement mechanism (17) each have a corresponding drive (23, 24, 25). In the depicted design examples, this drive is configured as a HRC-capable electric drive with an appropriately controllable or adjustable electric motor. There is also an appropriate gear mechanism for the transmission of force and motion. Said electric drives (23, 24, 25) are housed, for example, at the rear tool area and enclosed by the protective cover (4).

The electric drives (23, 24, 25) have an HRC-capable design, whereby their speed and the developed torque and/or the force are limited to HRC-permissible values. This focuses on the outwardly effective output elements of the respective driven mechanisms (17, 21, 22). Due to this limitation, in the event of a collision a corresponding device movement cannot cause injury. In addition, via an appropriate sensor system, the unexpected occurrence of resistance, in particular collisions, can be detected and used to control and/or adjust the corresponding drive (23, 24, 25). The drives (23, 24, 25) are connected to the robot control system in a suitable manner, for example, wired or wireless, and are actuated by the robot control system, if necessary, in coordination with the robot movements. Alternatively, the plug-setting tool (3) can exhibit its own integrated control system. Other modifications of the control architecture are possible as well.

Modifications of the depicted and described design examples are possible in a variety of ways. The features of the design examples can in particular be combined with one another in any number of ways and, as the case may be, even switched.

The plug (5) can also be set on otherwise configured setting positions or joints on a workpiece (6). These can, for example, be projections instead of the previously described workpiece openings.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE NUMBERS

1 Plug-setting device
2 Handling device, industrial robot
3 Plug-setting tool
4 Protective cover
5 Plug
6 Workpiece
7 Output link, robot hand
8 Output element
9 Sensor system
10 Frame
11 Connector
12 Plug magazine
13 Plug container
14 Mounting adapter
15 Magazine receiver
16 Opening, recess
17 Advancement mechanism
18 Setting unit
19 Plug receptacle
20 Rotating device
21 Swivel lock
22 Loading device
23 Drive advancement mechanism
24 Drive rotation unit
25 Drive loading device

What is claimed is:

1-18. (canceled)

19. A device for the automatic setting of plugs on workpieces, the plug-setting device comprising:
an industrial robot; and
a plug-setting tool carried by the industrial robot, the plug-setting tool including a plug magazine;
wherein the plug-setting device is designed for human-robot collaboration.

20. The plug-setting device of claim 19, wherein the plug-setting tool comprises a drive designed as a human-robot collaboration-compatible electrical drive, wherein the speed and the force or torque of the drive is limited to human-robot collaboration-permissible values.

21. The plug-setting device of claim 19, wherein the plug-setting tool further comprises a human-robot collaboration-compatible protective cover, the protective cover including an opening in the area of the plug magazine that is configured to facilitate automatically replacing the plug magazine or reloading the plug magazine.

22. The plug-setting device of claim 19, wherein the plug-setting tool is designed in a modular fashion and accommodates a variety of plug magazines adapted for different plug formats.

23. The plug-setting device of claim 19, wherein the plug-setting tool comprises a standard magazine receiver that accommodates a variety of plug magazines, each plug magazine including a plug container that is adapted to the plug format, and a standard mounting adapter that is adapted to the magazine receiver.

24. The plug-setting device of claim 23, wherein the magazine receiver and the mounting adapter are coupled in a detachable manner.

25. The plug-setting device of claim 24, wherein the magazine receiver and the mounting adapter are detachably coupled via a catch connection.

26. The plug-setting device of claim 19, wherein the plug-setting tool comprises:
a setting unit including a plug receptacle and a rotating device;
wherein the plug receptacle is aligned with the plug magazine during a setting operation and, through a relative axial movement under formation of an human-robot collaboration-safe closed contour, the plug receptacle and the plug magazine are positioned close together.

27. The plug-setting device of claim 19, wherein the plug receptacle and the plug magazine engage one another in a positive-locking manner during a setting operation, and define a swivel lock.

28. The plug-setting device of claim 19, wherein the plug-setting device comprises a human-robot collaboration-compatible tactile industrial robot with a sensor system that detects external loads.

29. A method for the automatic setting of plugs on workpieces with a plug-setting device that includes an industrial robot and a plug-setting tool, the method comprising:
carrying the plug-setting tool with the industrial robot, the plug-setting tool having a plug magazine;
wherein the plug-setting device is configured for human-robot collaboration and has a design that is suitable for this purpose.

30. The method of claim 29, wherein the advance and setting movements are executed by the industrial robot when setting the plug.

31. The method of claim 29, wherein the plug-setting tool is guided by a tactile industrial robot that is designed for human-robot collaboration.

32. The method of claim 31, further comprising:
Monitoring and evaluating external loads with a sensor system associated with the tactile industrial robot.

33. The method of claim 32, wherein the sensor system is integrated in the tactile industrial robot.

34. The method of claim 32, further comprising controlling and checking the automatic setting process based on the monitored external loads that occur during the setting process.

35. The method of claim 29, further comprising:
detecting a load profile with at least one sensor; and
based on the detected load profile, performing at least one of:
determining a correct plug position on the workpiece, or
monitoring process quality.

36. The method of claim 29, further comprising limiting the speed and the force or torque of a drive of the plug-setting device to human-robot collaboration-permissible values.

37. The method of claim 29, further comprising shielding the plug-setting tool with a human-robot collaboration-compatible protective cover.

38. The method of claim 29, wherein the plug-setting device includes a plug magazine connectable with the plug-setting tool, the method further comprising automatically replacing or reloading the plug magazine.
